(19) United States
(12) Patent Application Publication
(10) Pub. No.: US 2006/0093233 A1
(43) Pub. Date: May 4, 2006

(54) Ringing reduction apparatus and computer-readable recording medium having ringing reduction program recorded therein

(75) Inventors: Hiroshi Kano, Kyotanabe City (JP); Ryuuichirou Tominaga, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/258,354

(22) Filed: Oct. 26, 2005

(30) Foreign Application Priority Data
Oct. 29, 2004 (JP) 2004-316648

(51) Int. Cl. G06K 9/40

(52) U.S. Cl. 382/254

(57) ABSTRACT

A ringing reduction apparatus includes image restoration means for restoring an input image with image degradation to the image with less degradation using an image restoration filter; and weighted average means for performing weighted average of the input image and the restoration image obtained by the image restoration means. In the ringing reduction apparatus, the weighted average means performs the weighted average of the input image and the restoration image such that a degree of the input image is strengthened in a portion where ringing is conspicuous in the restoration image, and the weighted average means performs the weighted average of the input image and the restoration image such that a degree of the restoration image is strengthened in a portion where ringing is inconspicuous in the restoration image.

### BACKGROUND OF THE INVENTION

1. Field of the Invention

The present invention relates to a ringing reduction apparatus and a computer-readable recording medium having a ringing reduction program recorded therein.

2. Description of the Related Art

A still image camera shake correction technology reduces blurring of images due to hand movement while taking still images. A hand movement (camera shake) is detected and an image is stabilized based on the detection result, thereby realizing the still image camera shake correction technology.

A method of detecting the camera shake includes a method in which a camera shake sensor (angular velocity sensor) is used and an electronic method of analyzing the image to detect the camera shake. A method of stabilizing the image includes an optical method of stabilizing a lens and an image pickup device and an electronic method of reducing blurring caused by the camera, shake by image processing.

On the other hand, the full-electronic camera shake correction technology, i.e., analyzing and processing only one image with camera shake blurring and thereby generating an image with reduced camera shake blurring has not yet been developed to a practical level. Particularly it is difficult that a camera shake signal having accuracy obtained by a camera shake sensor is determined by analyzing one image with camera shake blurring.

Therefore, it is realistic that the camera shake is detected by the camera shake sensor and the camera shake blurring is reduced by the image processing with the camera shake data. The burring reduction performed by the image processing is called image restoration. A technique performed by the camera shake sensor and the image restoration shall be called electronic camera shake correction.

When an image degradation process due to the camera shake, defocusing, or the like is clear, the degradation can be reduced by using an image restoration filter such as a Wiener filter and a general inverse filter. However, an undulated degradation called ringing which is of an adverse effect is generated on the periphery of an edge portion of the image. The ringing is a phenomenon similar to overshoot and undershoot on the periphery of the edge portion. The overshoot and undershoot are seen in simple edge enhancement processing, unsharp masking, and the like.

### SUMMARY OF THE INVENTION

An object of the invention is to provide a ringing reduction apparatus that can reduce the ringing generated in the image restore with the image restoration filter and a computer-readable recording medium having a ringing reduction program recorded therein.

A first aspect of the invention is a ringing reduction apparatus including image restoration means for restoring an input image with image degradation to the image with less degradation using an image restoration filter; and weighted average means for performing weighted average of the input image and the restoration image obtained by the image restoration means, wherein the weighted average means performs the weighted average of the input image and the restoration image such that a degree of the input image is strengthened in a portion where ringing is conspicuous in the restoration image, and the weighted average means performs the weighted average of the input image and the restoration image such that a degree of the restoration image is strengthened in a portion where the ringing is inconspicuous in the restoration image.

A second aspect of the invention is a ringing reduction apparatus including image restoration means for restoring an input image with image degradation to the image with less degradation using an image restoration filter; edge intensity computing means for computing edge intensity in each pixel of the input image; and weighted average means for performing weighted average of the input image and the restoration image obtained by the image restoration means in each pixel based on the edge intensity in each pixel computed by the edge intensity computing means, wherein the weighted average means performs the weighted average of the input image and the restoration image such that a degree of the input image is strengthened for the pixel having the small edge intensity, and the weighted average means performs the weighted average of the input image and the restoration image such that a degree of the restoration image is strengthened for the pixel having the large edge intensity.

A third aspect of the invention is a ringing reduction apparatus including edge intensity computing means for computing edge intensity in each pixel of an input image with image degradation; selection means for selecting one image restoration filter in each pixel from plural image restoration filters having different degrees of image restoration intensity based on the edge intensity in each pixel computed by the edge intensity computing means; and image restoration means for restoring a pixel value of each pixel of the input image to the pixel value with less degradation using the image restoration filter selected for the pixel, wherein the selection means selects the image restoration filter having weak restoration intensity for the pixel having the small edge intensity, and the selection means selects the image restoration filter having strong restoration intensity for the pixel having the large edge intensity.

A fourth aspect of the invention is a computer-readable recording medium having a ringing reduction program recorded therein, wherein the ringing reduction program for causing a computer to function as image restoration means for restoring an input image with image degradation to the image with less degradation using an image restoration filter; and weighted average means for performing weighted average of the input image and the restoration image obtained by the image restoration means, is recorded in the computer-readable recording medium, the weighted average means performs the weighted average of the input image and the restoration image such that a degree of the input image is strengthened in a portion where ringing is conspicuous in the restoration image, and the weighted average means performs the weighted average of the input image and the restoration image such that a degree of the restoration image is strengthened in a portion where the ringing is inconspicuous in the restoration image.

A fifth aspect of the invention is a computer-readable recording medium having a ringing reduction program recorded therein, wherein the ringing reduction program for causing a computer to function as image restoration means for restoring an input image with image degradation to the image with less degradation using an image restoration filter; edge intensity computing means for computing edge intensity in each pixel of the input image; and weighted average means for performing weighted average of the input image and the restoration image obtained by the image restoration means in each pixel based on the edge intensity in each pixel computed by the edge intensity computing means, is recorded in the computer-readable recording medium, the weighted average means performs the weighted average of the input image and the restoration image such that a degree of the input image is strengthened for the pixel having the small edge intensity, and the weighted average means performs the weighted average of the input image and the restoration image such that a degree of the restoration image is strengthened for the pixel having the large edge intensity.

A sixth aspect of the invention is a computer-readable recording medium having a ringing reduction program recorded therein, wherein the ringing reduction program for causing a computer to function as edge intensity computing means for computing edge intensity in each pixel of an input image with image degradation; selection means for selecting one image restoration filter in each pixel from plural image restoration filters having different degrees of image restoration intensity based on the edge intensity in each pixel computed by the edge intensity computing means; and image restoration means for restoring a pixel value of each pixel of the input image to the pixel value with less degradation using the image restoration filter selected for the pixel, is recorded in the computer-readable recording medium, the selection means selects the image restoration filter having weak restoration intensity for the pixel having the small edge intensity, and the selection means selects the image restoration filter having strong restoration intensity for the pixel having the large edge intensity.

### BRIEF DESCRIPTION OF THE DRAWINGS

FIG. 1 is a block diagram showing a configuration of a camera shake correction processing circuit provided in a digital camera;

FIG. 2 is a block diagram showing an amplifier which amplifies output of an angular velocity sensor 1a and an A/D converter which converts amplifier output into a digital value;

FIG. 3 is a schematic view showing a relationship between a rotating amount θ (deg) of camera and a moving amount d (mm) on a screen;

FIG. 4 is a schematic view showing a 35 mm film-conversion image-size and an image size of the digital camera;

FIG. 5 is a schematic view showing a spatial filter (PSF) which expresses camera shake;

FIG. 6 is a schematic view for explaining Bresenham line-drawing algorithm;

FIG. 7 is a schematic view showing PSF obtained by a motion vector;

FIG. 8 is a schematic view showing a 3×3 area centered on a target pixel v22;

FIGS. 9A and 9B are a schematic view showing a Prewitt edge extraction operator; and

FIG. 10 is a graph showing a relationship edge intensity v_edge and a weighted average coefficient k.

### DESCRIPTION OF THE PREFERRED EMBODIMENT

Preferred embodiment in which the present invention is applied to a digital camera will be described below with reference to the drawings.

1. Configuration of Camera Shake Correction Processing Circuit

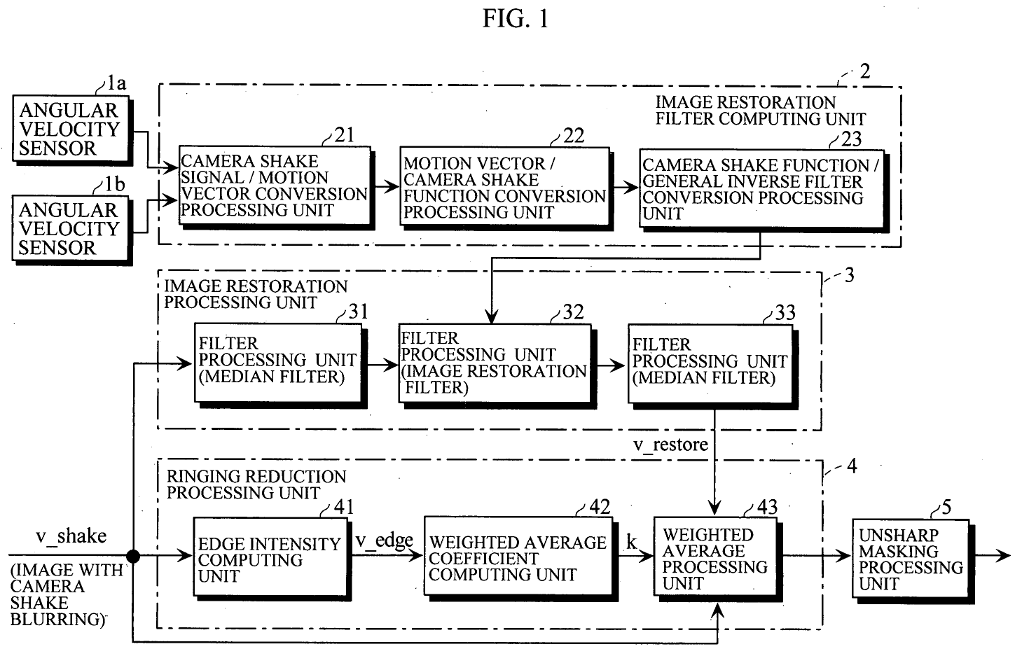

FIG. 1 shows a configuration of a camera shake correction processing circuit provided in the digital camera.

Reference numerals 1a and 1b designate angular velocity sensors which detect angular velocity. The angular velocity sensor 1a detects the angular velocity in a pan direction of the camera, and the angular velocity sensor 1b detects the angular velocity in a tilt direction of the camera. Numeral 2 designates an image restoration filter computing unit which computes an image restoration filter coefficient based on the two-axis angular velocity detected by the angular velocity sensors 1a and 1b. Numeral 3 designates an image restoration processing unit which performs image restoration processing to the pickup image (camera shake image) based on the coefficient computed by the image restoration filter computing unit 2. Numeral 4 designates a ringing reduction processing unit which reduces the ringing from the restoration image obtained by the image restoration processing unit 3. Numeral 5 designates an unsharp masking processing unit which performs unsharp masking processing to the image obtained by the ringing reduction processing unit 4.

The following describes the image restoration filter computing unit 2, the image restoration processing unit 3, and the ringing reduction processing unit 4.

2. Image Restoration Filter Computing Unit 2

The image restoration filter computing unit 2 includes a camera shake signal/motion vector conversion processing unit 21, a motion vector/camera shake function conversion processing unit 22, and a camera shake function/general inverse filter conversion processing unit 23. The camera shake signal/motion vector conversion processing unit 21 converts angular velocity data (camera shake signal) detected by the angular velocity sensors 1a and 1b into a motion vector. The motion vector/camera shake function conversion processing unit 22 converts the motion vector obtained by the camera shake signal/motion vector conversion processing unit 21 into a camera shake function (PSF: Point Spread Function) expressing image blurring. The camera shake function/general inverse filter conversion processing unit 23 converts the camera shake function obtained by the motion vector/camera shake function conversion processing unit 22 into a general inverse filter (image restoration filter).

2-1 Camera Shake Signal/Motion Vector Conversion Processing Unit 21

The original data of the camera shake is the pieces of output data of the angular velocity sensors 1a and 1b between shooting start and shooting end. Once the shooting is started, in synchronization with an exposure period of the camera, the angular velocities in the pan and tilt directions are measured at predetermined sampling intervals dt (s) using the angular velocity sensors 1a and 1b, and the data is obtained until the shooting is ended. For example, the sampling interval dt (S) is 1 ms.

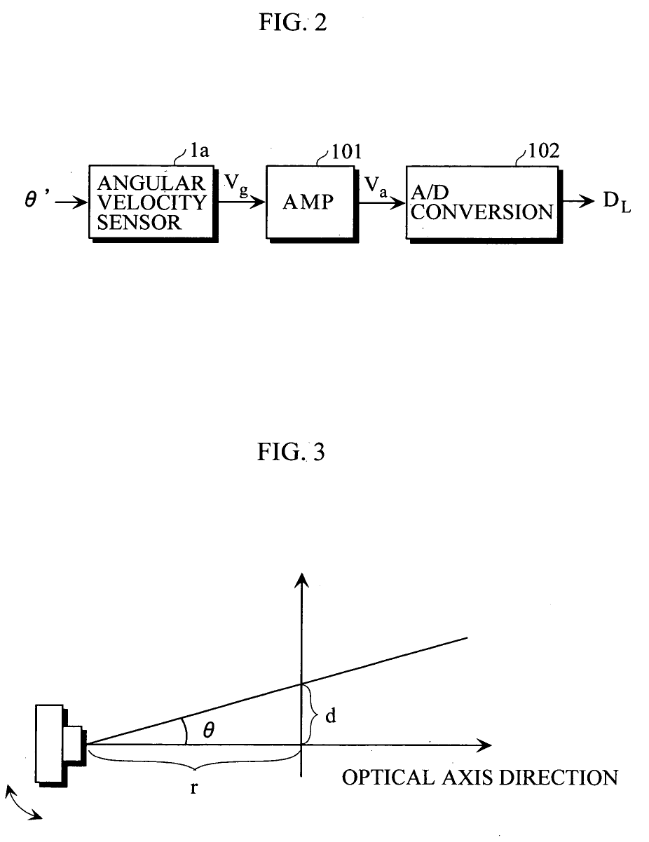

As shown in FIG. 2, for example, an angular velocity θ′ (deg/s) in the pan direction of the camera is converted into a voltage V_{g} (mV) by the angular velocity sensor 1a, and then the voltage V_{g} is amplified by an amplifier 101. A voltage Vₐ (mV) outputted from the amplifier 101 is converted into a digital value D_{L} (step) by an A/D converter 102. In order to convert the data obtained in the form of the digital value into the angular velocity, the computation is performed with sensor sensitivity S (mV/deg/s), an amplifier amplification factor K (time) and an A/D conversion coefficient L (mV/step). The amplifier and the A/D converter are provided in each of the angular velocity sensors 1a and 1b. The amplifiers and the A/D converters are provided in the camera shake signal/motion vector conversion processing unit 21.

The voltage V_{g} (mV) obtained by the angular velocity sensor 1a is proportional to the angular velocity θ′ (deg/s). At this point, since a constant of proportion is the sensor sensitivity, voltage V_{g} (mV) is shown by the following expression (1).
V_{g}=sθ′ (1)

Since only the amplifier 101 amplifies the voltage, the amplified voltage Vₐ (mV) is shown by the following expression (2).
Vₐ=KV_{g} (2)

The A/D conversion is performed to the voltage Vₐ (mV) amplified by the amplifier 101, and the voltage Vₐ (mV) is expressed by using the digital value D_{L} (step) having n (step) (for example, from −512 to 512). Assuming that the A/D conversion coefficient is L (mV/step), the digital value D_{L} (step) is shown by the following expression (3).
D_{L}=Vₐ/L (3)

As shown in the following expression (4), the angular velocity can be determined from the sensor data by using the above expressions (1) to (3).
θ′=(L/KS)D_{L} (4)

How much the blurring is generated on the taken image can be computed from the angular velocity data during the shooting. Apparent motion on the image is referred to as motion vector.

A rotating amount generated in the camera between one sample value and the subsequent sample value in the angular velocity data is set θ (deg). Between one sample value and the subsequent sample value, it is assumed that the camera is rotated while the angular velocity is kept constant. When a sampling frequency is set at f=1/dt (Hz), θ (deg) is shown by the following expression (5).
θ=θ′/f=(L/KSf)D_{L} (5)

As shown in FIG. 3, when a focal distance (35 mm film conversion) is set at r (mm), a moving amount d (mm) on the screen is determined from the rotating amount θ (deg) of the camera by the following expression (6).
d=r tan θ (6)

At this point, the determined moving amount d (mm) is magnitude of the camera shake in the 35 mm film conversion, and unit is (mm). In the actual computing processing, it is necessary that the image size is considered in unit (pixel) of the image size of the digital camera.

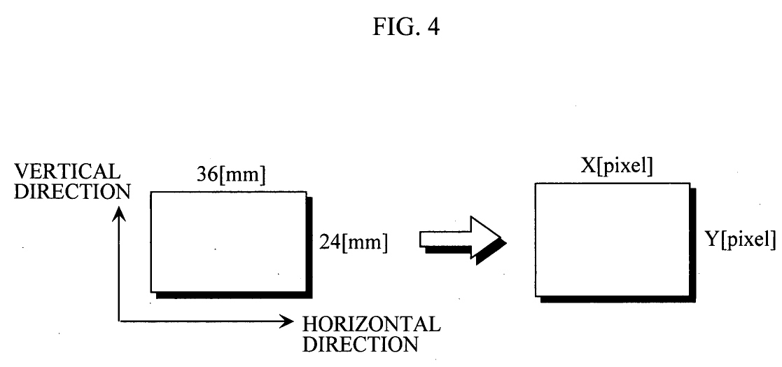

The 35 mm film-conversion image differs from the image in unit (pixel) taken with the digital camera in an aspect ratio, so that the following computation is performed. As shown in FIG. 4, in the 35 mm film conversion, 36 (mm)×24 (mm) is defined as a horizontal to vertical ratio of the image size. The size of the image taken with the digital camera is set at X (pixel)×Y (pixel), the blurring in the horizontal direction (pan direction) is set at x (pixel), and the blurring in the vertical direction (tilt direction) is set at y (pixel). Then, the conversion equations become the following expressions (7) and (8).
x=dₓ(X/36)=r tan θₓ(X/36) (7)
y=d_{y}(Y/24)=r tan θ_{y}(Y/24) (8)

In the above expressions (7) and (8 ), suffixes x and y are used in d and θ. The suffix x indicates the value in the horizontal direction, and the suffix y indicates the value in the vertical direction.

When the above expressions (1) to (8) are summarized, the blurring x (pixel) in the horizontal direction (pan direction) and the blurring y (pixel) in the vertical direction (tilt direction) are shown by the following expressions (9) and (10).
x=r tan {(L/KSf)D_{Lx}}X/36 (9)
y=r tan {(L/KSf)D_{Ly}}Y/24 (10)

The burring amount of image (motion vector) can be determined from the angular velocity data of each axis of the camera, obtained in the form of the digital value, by using the conversion equations (9) and (10).

The motion vectors during the shooting can be obtained to the number of pieces of angular velocity data (the number of sample points) obtained from the sensor. When start points and end points of the motion vectors are connected, a camera shake locus on the image is obtained. The velocity of the camera shake at that point is learned by checking the magnitude of each vector.

2-2 Motion Vector/Camera Shake Function Conversion Processing Unit 22

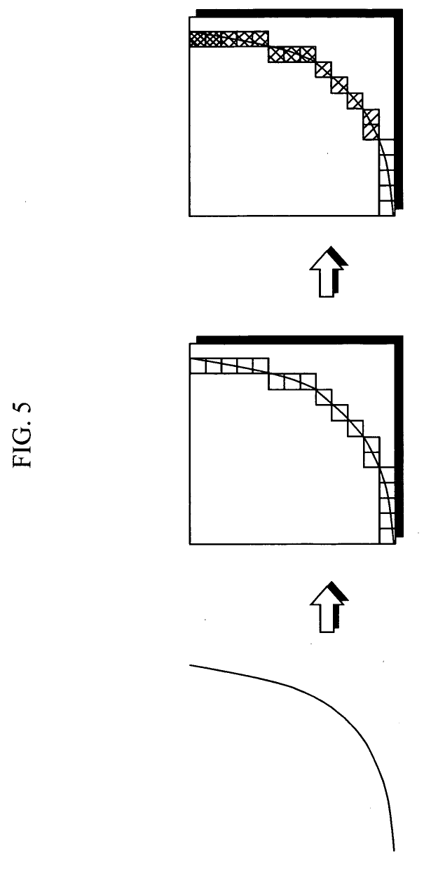

The camera shake can be expressed by using a spatial filter. When spatial filter processing is performed by weighting the element of the operator in accordance with the camera shake locus (the locus drawn by one point on the image when the camera is shaken, the blurring amount of image) shown on the left side of FIG. 5, because only a gray value of the pixel near the camera shake locus is considered in the filtering process, the camera shake image can be produced.

The operator in which the weighting is performed in accordance with the locus is referred to as Point Spread Function (PSF). PSF is used as a mathematical model of the camera shake. The weight of each element of PSF is the value proportional to a time when the camera shake locus passes through the element, and the weight of each element of PSF is the value which is normalized such that a summation of the weights of the elements becomes one. That is, the weight of each element of PSF is set at the weight which is proportional to an inverse number of the magnitude of the motion vector. This is because the position which is moved more slowly has the large influence on the image in consideration of the influence of the camera shake on the image.

The center of FIG. 5 shows PSF in the case where it is assumed that the camera shake is moved at constant speed, and the right side of FIG. 5 shows PSF in the case where the magnitude of the actual camera shake motion is considered. In the right-side view of FIG. 5, the element in which the weight of PSF is low (the magnitude of the motion vector is large) is indicated by black, and the element in which the weight of PSF is high (the magnitude of the motion vector is small) is indicated by white.

The motion vector (blurring amount of image) obtained in the above (2-1) has a locus of the camera shake and a camera shake velocity in the form of the data.

In order to produce PSF, first a weighted element in PSF is determined from the camera shake locus. Then, the weight applied to the element of PSF is determined from the camera shake velocity.

The camera shake locus in which polygonal line approximation is performed by connecting a series of motion vectors obtained in the above (2-1). Although the locus has accuracy not more than a fractional part, the element weighted in PSF is determined by rounding the locus to the whole number. Therefore, in the embodiment, the element weighted in PSF is determined with Bresenham line-drawing algorithm. The Bresenham line-drawing algorithm is one which selects the optimum dot position when a straight line passing through two arbitrary points is drawn on the digital screen.

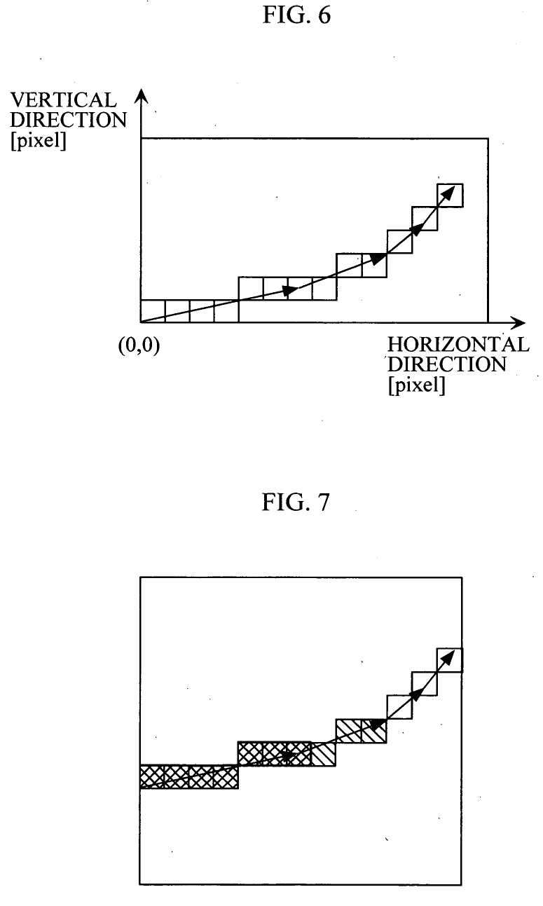

The Bresenham line-drawing algorithm will be described with reference to FIG. 6. Referring to FIG. 6, a straight line with an arrow indicates the motion vector.

(a) Starting from an origin (0,0) of the dot position, and an element in the horizontal direction of the motion vector is incremented by one.

(b) Confirming the position in the vertical direction of the motion vector, and the dot position in the vertical direction is incremented by one in the case where the position in the vertical direction of the motion vector is larger than one compared with the position in the vertical direction of the previous dot.

(c) The element in the horizontal direction of the motion vector is incremented by one again.

The straight line through which the motion vector passes can be expressed with the dot positions by repeating the above processes up to the end point of the motion vector.

The weight applied to the element of PSF is determined by utilizing difference in magnitude of the vector (velocity component) in each motion vector. The weight is the inverse number of the magnitude of the motion vector, and is substituted for the element corresponding to each motion vector. However, the weight of each element is normalized such that the summation of the weights of the elements becomes one. FIG. 7 shows PSF obtained by the motion vector of FIG. 6. The weight is decreased in the area where the velocity is fast (the motion vector is long), and the weight is increased in the area where the velocity is slow (the motion vector is short).

2-3 Camera Shake Function/General Inverse Filter Conversion Processing Unit 23

It is assumed that the image is digitized with resolution of Nₓ pixels in the horizontal direction and N_{y} pixels in the vertical direction. A value of the pixel located in i-th in the horizontal direction and j-th in the vertical direction is indicated by P (i, j). The image transform with the spatial filter shall mean that modeling of the transform is performed by convolution of the pixels near the target pixel. A coefficient of the convolution is set at h(l,m). For the sake of convenience, letting −n<1 and m<n, the transform of the target pixel can be expressed by the following expression (11). Sometimes h(l,m) itself is referred to as spatial filter or filter coefficient. A property of the transform is determined by the coefficient of h(l,m).

$${P}^{′} ( i , j ) = {\sum }_{l = - n}^{l = n} {\sum }_{m = - n}^{m = n} h ( l , m ) \times p ( i + l , j + m ) \qquad ( 11 )$$

In the case where a point light source is observed with the image pickup apparatus such as the digital camera, assuming that the degradation does not exist in the image forming process, only one point has a pixel value except for zero while other pixels except for the one point have the value of zero in the image observed on the image pickup apparatus. Because the actual image pickup apparatus includes the degradation process, even if the point light source is observed, the image does not become the one point, but the image becomes broadened. In the case where the camera shake is generated, the point light source generates the locus according to the camera shake.

The spatial filter, in which the coefficient is the value proportional to the pixel value of the image observed for the point light source and the summation of the coefficients becomes one, is referred to as Point Spread Function (PSF). PSF obtained by the motion vector/camera shake function conversion processing unit 22 is used in the embodiment.

When the modeling of PSF is performed with the spatial filter h(l,m) of the vertical to horizontal ratio of (2n+1)×(2n+1) and −n<l and m<n, the relation of the above expression (11) is obtained for the pixel value P(i,j) of the image without the blurring and the pixel value P′ (i,j) of the image with the blurring with respect to each pixel. At this point, only the pixel value P′ (i,j) of the image with the blurring can actually be observed, it is necessary that the pixel value P(i,j) of the image without the blurring is computed by a method of some kind.

When the above expression (11) is written for all the pixels, the following expressions (12) are obtained.

$${P}^{′} ( 1 , 1 ) = {\sum }_{l = - n}^{l = n} {\sum }_{m = - n}^{m = n} h ( l , m ) \times p ( 1 + l , 1 + m ) \\ {P}^{′} ( 1 , 2 ) = {\sum }_{l = - n}^{l = n} {\sum }_{m = - n}^{m = n} h ( l , m ) \times p ( 1 + l , 2 + m ) \\ … \\ {P}^{′} ( 1 , {N}_{n} ) = {\sum }_{l = - n}^{l = n} {\sum }_{m = - n}^{m = n} h ( l , m ) \times p ( 1 + l , {N}_{n} + m ) \\ {P}^{′} ( 2 , {N}_{n} ) = {\sum }_{l = - n}^{l = n} {\sum }_{m = - n}^{m = n} h ( l , m ) \times p ( 2 + l , {N}_{n} + m ) \\ … \\ {P}^{′} ( {N}_{y} , {N}_{n} ) = {\sum }_{l = - n}^{l = n} {\sum }_{m = - n}^{m = n} h ( l , m ) \times p ( {N}_{y} + l , {N}_{n} + m ) \qquad ( 12 )$$

These expressions (12) can be summarized and expressed in a matrix, and the following expression (13) is obtained. Where P is unification of the original image in the order of raster scan.
P′=H×P (13)

When the inverse matrix H⁻¹ of H exists, the image P with less degradation can be determined from the degraded image P′ by computing P=H⁻¹×P. However, generally the inverse matrix of H does not exist. For the matrix in which the inverse matrix does not exist, there is an inverse matrix called general inverse matrix or pseudo-inverse matrix. An example of the general inverse matrix is shown in the following expression (14).
H*=(H^{t}·H+γ·I)⁻¹·H^{t} (14)

Where H* is the general inverse matrix of H, H^{t} is the transpose of H, γ is a scalar, and I is a unit matrix having the same size as H^{t}·H. The image P in which the camera shake is corrected can be obtained from the observed camera shake image P′ by computing the following expression (15) with H*. γ is a parameter for adjusting correction intensity. When γ is small, the correction processing becomes strong. When γ is large, the correction processing becomes weak.
P′=H*×p (15)

In the case where the image size is set at 640×480, P in the above expression (15) becomes the matrix of 307, 200×1, and H* becomes the matrix of 307, 200×307, 200. Due to such the large matrices, the use of the above expressions (14) and (15) is not practical. Therefore, the sizes of the matrices used for the computation are decreased by the following method.

First, in the above expression (15), the size of the image which becomes the original of P is decreased to the relatively small size such as 63×63. When the size of the image is 63×63, P is the matrix of 3969×1, and H* becomes the matrix of 3969×3969. H* is the matrix which transforms the whole of the image with the blurring into the whole of the corrected image, and a product of each row of H and P corresponds to the computation for performing the correction of each element. The product of the central row of H* and P corresponds to the correction of the original image of the 63×63 pixels with respect to the central pixel. Since P is the unification of the original image in the order of raster scan, adversely the spatial filter having the size of 63×63 can be formed by generating two-dimensional expression of the central row of H*. The spatial filter formed in the above manner is called general inverse filter (hereinafter referred to as image restoration filter).

The spatial filter having the practical size, produced in the above manner, is sequentially applied to each pixel of the whole of the large image, which allows the blurring image to be corrected. The parameter, expressed by γ, for adjusting the restoration intensity also exists in the restoration filter for the blurring image determined by the above procedure.

3. Image Restoration Processing Unit 3

As shown in FIG. 1, the image restoration processing unit 3 includes filter processing units 31, 32, and 33. The filter processing units 31 and 33 perform the filter processing with a median filter. The filter processing unit 32 performs the filter processing with the image restoration filter obtained by the image restoration filter computing unit 2.

The camera shake image taken by the camera is transmitted to the filter processing unit 31, and the filter processing is performed with the median filter to reduce noise. The image obtained by the filter processing unit 31 is transmitted to the filter processing unit 32. In the filter processing unit 32, the filter processing is performed with the image restoration filter to restore the image having no camera shake from the camera shake image. The image obtained by the filter processing unit 32 is transmitted to the filter processing unit 33, and the filter processing is performed with the median filter to reduce noise.

4. Ringing Reduction Processing Unit 4

As shown in FIG. 1, the ringing reduction processing unit 4 includes an edge intensity computing unit 41, a weighted average coefficient computing unit 42, and a weighted average processing unit 43.

The camera shake image taken by the camera is transmitted to the edge intensity computing unit 41, and edge intensity is computed in each pixel. The method of determining the edge intensity will be described.

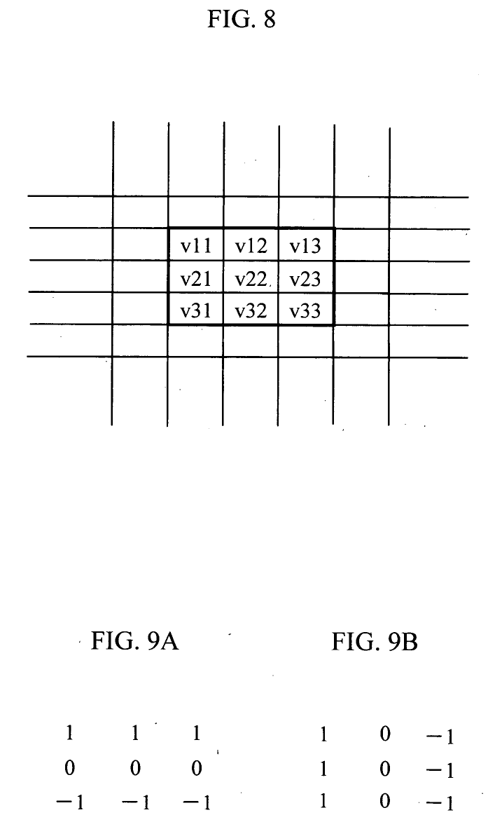

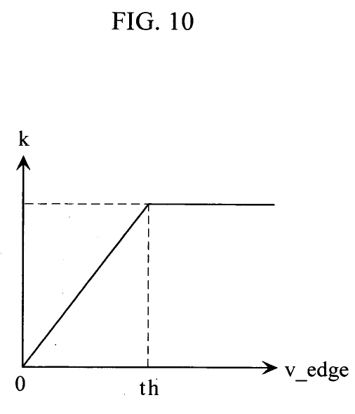

A 3×3 area centered on a target pixel v22 is assumed as shown in FIG. 8. A horizontal edge component dh and a vertical edge component dv are computed for the target pixel v22. For example, a Prowitt edge extraction operator shown in FIGS. 9A and 9B is used for the computation of the edge component. FIG. 9A shows a horizontal edge extraction operator, and FIG. 9B shows a vertical edge extraction operator.

The horizontal edge component dh and the vertical edge component dv are determined by the following expressions (16) and (17).
dh=v11+v12+v13−v31−v32−v33 (16)
dv=v11+v21+v31−v13−v23−v 33 (17)

Then, edge intensity v_edge of the target pixel v22 is computed from the horizontal edge component dh and the vertical edge component dv based on the following expression (18).
v_edge=sqrt(dh×dh+dv×dv) (18)

At this point, abs(dh)+abs (dv) may be used as the edge intensity v_edge of the target pixel v22. Further, a 3×3 noise reduction filter may further be applied to the edge intensity image obtained in the above manner.

The edge intensity v_edge of each pixel obtained by the edge intensity computing unit 41 is given to the weighted average coefficient computing unit 42. The weighted average coefficient computing unit 42 computes the weighted average coefficient k of each pixel based on the following expression (19).
If v_edge>th then k=1
If v_edge<th then k=v_edge/th (19)

Where th is a threshold for determining whether the edge intensity v_edge is sufficiently strong edge. That is, the edge intensity v_edge and the weighted average coefficient k have a relationship shown in FIG. 10.

The weighted average coefficient computing unit 42 gives the computed weighted average coefficient k of each pixel to the weighted average processing unit 43. A pixel value of the restoration image obtained by the image restoration processing unit 3 is set at v_restore, and a pixel value of the camera shake image taken by the camera is set at v_shake. Then, the weighted average processing unit 43 performs the weighted average of the pixel value v_restore of the restoration image and the pixel value v_shake of the camera shake image by performing the computation shown by the following expression (20).
v=k×v_restore+(1−k)×v_shake (20)

That is, for the pixel in which the edge intensity v_edge is larger than the threshold th, because the ringing of the restoration image corresponding to the position of the pixel is inconspicuous, the pixel value v_restore of the restoration image obtained by the image restoration processing unit 3 is directly outputted. For the pixel in which the edge intensity v_edge is not more than the threshold th, because the ringing of the restoration image is conspicuous as the edge intensity v_edge is decreased, a degree of the restoration image is weakened and a degree of the camera shake image is strengthened.

In the above embodiment, the weighted addition of the restoration image and the camera shake image is performed such that the degree of the restoration image is strengthened in the pixel where the edge intensity v_edge is increased and the degree of the camera shake image is strengthened in the pixel where the edge intensity v_edge is decreased, which reduces the ringing generated on the periphery of the edge portion. Alternatively, the ringing maybe reduced as follows.

As described above, in the image restoration filter (numeral 32 of FIG. 1) for the blurring image, there is also a parameter for adjusting the restoration magnitude indicated by γ. Therefore, it is possible that plural kinds of the restoration filters are generated according to the restoration magnitude. When the pixel having the large edge intensity v_edge is restored, since the ringing of the corresponding restoration image is inconspicuous, the image is restored with the restoration filter having the high restoration intensity. When the pixel having the small edge intensity v_edge is restored, since the ringing of the corresponding restoration image is conspicuous, the image is restored with the restoration filter having the low restoration intensity. Therefore, in the case where the ringing is prevented, it is not necessary to perform the weighted average.

What is claimed is:

1. A ringing reduction apparatus comprising:
image restoration means for restoring an input image with image degradation to the image with less degradation using an image restoration filter; and
weighted average means for performing a weighted average of the input image and the restoration image obtained by the image restoration means,
wherein the weighted average means performs the weighted average of the input image and the restoration image such that a degree of the input image is strengthened in a portion where ringing is conspicuous in the restoration image, and
the weighted average means performs the weighted average of the input image and the restoration image such that a degree of the restoration image is strengthened in a portion where the ringing is inconspicuous in the restoration image.

2. A ringing reduction apparatus comprising:
image restoration means for restoring an input image with image degradation to the image with less degradation using an image restoration filter;
edge intensity computing means for computing edge intensity in each pixel of the input image; and
weighted average means for performing weighted average of the input image and the restoration image obtained by the image restoration means in each pixel based on the edge intensity in each pixel computed by the edge intensity computing means,
wherein the weighted average means performs the weighted average of the input image and the restoration image such that a degree of the input image is strengthened for the pixel having the small edge intensity, and
the weighted average means performs the weighted average of the input image and the restoration image such that a degree of the restoration image is strengthened for the pixel having the large edge intensity.

3. A ringing reduction apparatus comprising:
edge intensity computing means for computing edge intensity in each pixel of an input image with image degradation;
selection means for selecting one image restoration filter in each pixel from a plurality of image restoration filters having different degrees of image restoration intensity based on the edge intensity in each pixel computed by the edge intensity computing means; and
image restoration means for restoring a pixel value of each pixel of the input image to the pixel value with less degradation using the image restoration filter selected for the pixel,
wherein the selection means selects the image restoration filter having weak restoration intensity for the pixel having the small edge intensity, and
the selection means selects the image restoration filter having strong restoration intensity for the pixel having the large edge intensity.

4. A computer-readable recording medium having a ringing reduction program recorded therein,
wherein the ringing reduction program for causing a computer to function as
image restoration means for restoring an input image with image degradation to the image with less degradation using an image restoration filter; and
weighted average means for performing weighted average of the input image and the restoration image obtained by the image restoration means, is recorded in the computer-readable recording medium,
the weighted average means performs the weighted average of the input image and the restoration image such that a degree of the input image is strengthened in a portion where ringing is conspicuous in the restoration image, and
the weighted average means performs the weighted average of the input image and the restoration image such that a degree of the restoration image is strengthened in a portion where the ringing is inconspicuous in the restoration image.

5. A computer-readable recording medium having a ringing reduction program recorded therein,
wherein the ringing reduction program for causing a computer to function as
image restoration means for restoring an input image with image degradation to the image with less degradation using an image restoration filter;
edge intensity computing means for computing edge intensity in each pixel of the input image; and
weighted average means for performing weighted average of the input image and the restoration image obtained by the image restoration means in each pixel based on the edge intensity in each pixel computed by the edge intensity computing means, is recorded in the computer-readable recording medium,
the weighted average means performs the weighted average of the input image and the restoration image such that a degree of the input image is strengthened for the pixel having the small edge intensity, and
the weighted average means performs the weighted average of the input image and the restoration image such that a degree of the restoration image is strengthened for the pixel having the large edge intensity.

6. A computer-readable recording medium having a ringing reduction program recorded therein,
wherein the ringing reduction program for causing a computer to function as
edge intensity computing means for computing edge intensity in each pixel of an input image with image degradation;
selection means for selecting one image restoration filter in each pixel from a plurality of image restoration filters having different degrees of image restoration intensity based on the edge intensity in each pixel computed by the edge intensity computing means; and
image restoration means for restoring a pixel value of each pixel of the input image to the pixel value with less degradation using the image restoration filter selected for the pixel, is recorded in the computer-readable recording medium,
the selection means selects the image restoration filter having weak restoration intensity for the pixel having the small edge intensity, and
the selection means selects the image restoration filter having strong restoration intensity for the pixel having the large edge intensity.
